(19) United States
(12) Patent Application Publication
(10) Pub. No.: US 2013/0275261 A1
(43) Pub. Date: Oct. 17, 2013

(54) SMART PRICE TAG SYSTEM INCLUDING REMOTE DISPLAY

(71) Applicant: Yehuda Yoked, Park City, UT (US)

(72) Inventor: Yehuda Yoked, Park City, UT (US)

(21) Appl. No.: 13/448,990

(22) Filed: Apr. 17, 2012

(51) Int. Cl. G06Q 10/08

(52) U.S. Cl. CPC G06Q 10/087
USPC 705/26.8; 235/385

(57) ABSTRACT

An electronic price tag system for stock keeping units (SKUs) having three components: an ID module, a Remote Display Module (RDM), and a remote display control module (RDCM). The ID module and/or the RDCM may contain display elements. The RDM receives information from a vendor's legacy central computer system (LCCS) or marketing computer system (MCS). Communication between the LCCS/MCS and the RDCM is mediated by an RF Communication Module. The RDCM is reusable and may have a limited transmission range to limit access to LCCS/MCS information and security elements triggered by unauthorized removal.

### FIELD OF THE INVENTION

The present invention relates to electronic price display systems.

### BACKGROUND OF THE INVENTION

Smart price tags facilitate the display of pricing information that is often in flux. They enable the merchant to reduce the expense of updating the display of sales price changes and allow the merchant to keep its pricing strategies secret from those through whose hands his inventory must pass.

Smart price tags provide multiple functions that require supporting elements. First, they contain identification codes for the priced item. These codes may identify the item, the manufacturer and the vendor and contain vendor codes to facilitate inventory control. Second, they contain display elements to enable a purchaser to view information about the priced item, such as size, quantity, quality, price and available discounts. Third, they contain hardware elements to allow the information stored in the price tag to be modified remotely or to be broadcast. Fourth, they contain power elements to enable the hardware elements and display elements to function. In order to make these price tags as practical as possible, a division of the tags into components has been suggested. In particular, it has been suggested to make the display elements reusable by providing a connection interface to an identification portion that remains with the goods when sold. The more expensive portions of the price tag are relegated to the reusable portion to the extent possible.

### BRIEF DESCRIPTION OF THE INVENTION

The following acronyms are used throughout this disclosure:
LCCS Legacy Central Computer System
MCS Marketing Computer Subsystem
RDCM Remote Display Controller Module
RDM Remote Display Module, e.g. Smartphone
RFCM RF Communication Module
RFID Radio Frequency Identification
SKU Stock Keeping Unit

A smart price tag system contains information that may be captured by and read from a mobile device running an application specifically designed for that purpose. The connection between the price tag and the mobile device is wireless. For example the connection may be through WiFi, Bluetooth, cellular phone technology, RF technology or RFID specific technology. The display components will be those inherently part of the mobile device. All aspects of the mobile device may be utilized for that purpose.

The RDM may display a customer shopping list and a map indicating the location of SKU's of interest to the customer. Where the mobile device is capable of determining its location within a store, it may suggest a route to the particular SKU and signals to indicate proximity. The RDM may allow the SKUs to be checked out and paid for without having to stop at a cash register. The RDM may provide a cumulative total cost of selected items for purchase. The RDM may allow access to a social network having product reviews by persons in whom the customer has confidence. The RDM may allow the customer to input its own product evaluations.

An electronic price tag system for stock keeping units (SKUs) has three components. The first component is an ID module that is physically attached to an SKU and is capable of storing information about the SKU appropriate for a price tag. The second component is a Remote Display Module (RDM) such as a mobile smart phone having sophisticated communication and display elements. The third component is a remote display control module (RDCM) that may be connected to but is separable from the ID module. The ID module and/or the RDCM may contain display elements for the information stored in the ID module. Further information and display is provided by the RDM which receives information from a vendor's legacy central computer system (LCCS) or marketing computer system (MCS) according to the communication and control exercised by the RDCM over such information. Communication between the LCCS/MCS and the RDCM is mediated by an RF Communication Module, which may restrict information from the LCCS/MCS. The RDCM is reusable and may contain a rechargeable battery. The RDCM may have a limited transmission range to limit access to LCCS/MCS information to users near the SKU and may have security elements that are triggered by unauthorized removal from a vendor's premises.

### BRIEF DESCRIPTION OF THE DRAWINGS

FIG. 1 is a logical drawing of the components that comprise a smart price tag system.

### DETAILED DESCRIPTION OF EXAMPLES OF THE INVENTION

The remote unit has three modules: an RFID sensor (or ID module), a remote display control module (RDCM), and a remote display module (RDM) (Smart phone or any other mobile hand held device).

The RDCM (Remote Display Control Module) is attached or connected (and paired with RFID sensor) to an SKU or directly to an RFID sensor at the point of SKU manufacturing or if so elected at other points of the supply chain. Its purposes are: to communicate with an RFID sensor and an RDM and to control the data to be displayed on the RDM display. An RDCM will include an embedded antenna, an RF transceiver, a rechargeable or replaceable power source, a CPU, and a command and control unit. Once excited by the RFCM receiving a command from the legacy central computer system (LCCS) and/or marketing computer subsystem (MCS) the RDCMs are continuously transmitting a SKU unique Omni RF signal with a strength designed to dissipate at a pre-defined range from the RDCM. Such a signal will be received by the RDM only when it has entered the pre-define range from the RDCM and allow for an application running on the RDM to recognize the unique SKU and accordingly route the SKU specific data from the LCCS and/or MCS to the RDM for display. An excite signal or stop signal may be transmitted by the LCCS and/or MCS to the RDCM and/or the RDM in accordance with store policy.

The RFID sensor is a passive device having no power source. It is embedded or attached to an SKU at the point of SKU manufacturing, or if so elected at other stages of the supply chain. Its purposes are to controlling inventory and shrinkage via communication with a legacy central computer system and to provide ID information to an RDCM via communication initiated by the RDCM.

The RDM (Remote Display Module) is carried by customers and is either a smart phone or a mobile device owned by customers or other hand held devices provided temporarily to customers upon entry to the store downloaded with a proprietary Application (APP) via internet (WI-FI) communication from the legacy central computer system of the store. When in a pre-defined vicinity of an RDCM or a cluster of RDCMs the RDM will display, upon command initiated by the RDCM, data residing on the legacy central computer system or on a dedicated marketing computer subsystem (MCS) such as pricing, advertising, marketing and any other pertinent data relating to a specific SKU.

The APP is an application designed specifically for each store/retailer/wholesaler/other user to be downloaded to and to operate on an RDM for the purpose of enabling the display of SKU specific data residing on the legacy central computer system or on a dedicated marketing computer subsystem. Display data is manipulated and selected by the RDCM when the RDM is in a pre-defined range from the SKU or a cluster of same SKUs.

The Legacy central computer system (LCCS) is the computer system that each store/retailer/wholesaler/other user has for operating its business model. The LCCS or a specifically designed Marketing Computer Subsystem (MCS) through an existing or otherwise added RF Communication Module (RFCM) communicates, collects, and provides data to and from its network of RF transceivers embedded in the RFID sensors and/or embedded in the RDCMs. Once the RDMs have been uploaded with the store APP by the LCCS and/or MCS they are ready to receive display data from the LCCS and/or MCS. Once an RDM has entered into a pre-defined range, the command and control signal from the RDCM will allow the APP to identify the specific SKU and allow data to stream to the RDM via WI-FI from the LCCS and/or MCS and display the price, advertising, marketing and other SKU specific data on the RDM display.

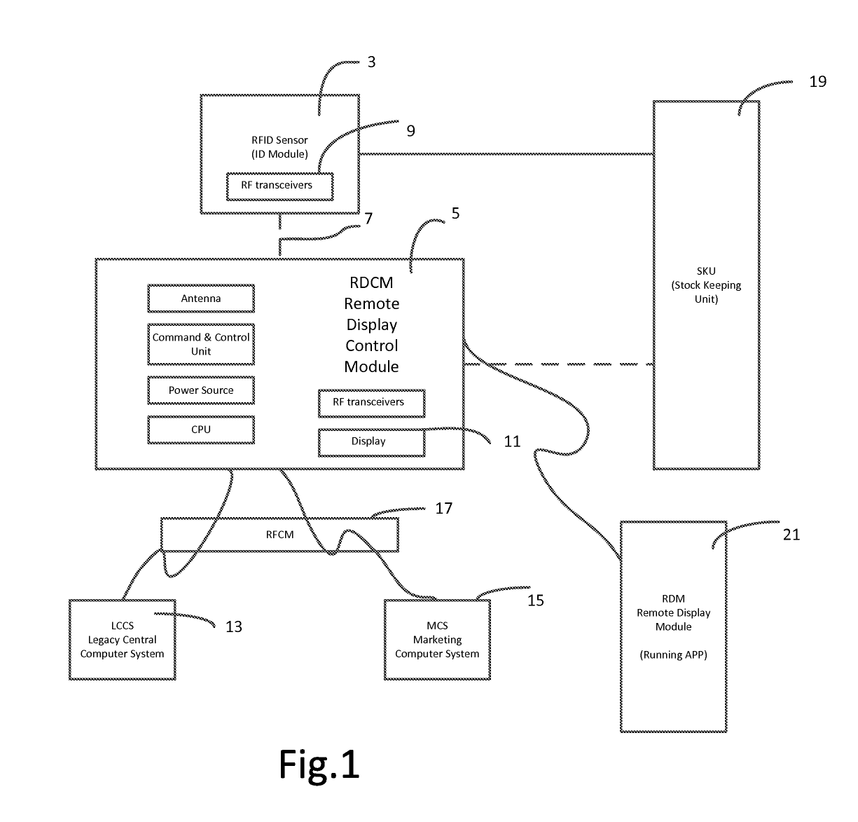

As depicted in FIG. 1, the system 1 comprises an RFID Sensor 3 alternately termed an ID Module, which contains RF transceivers 9 to allow communication with the RDCM Remote Display Control Module 5. The dashed line 7 indicates that the connection may either be by a physical tether or wirelessly. The RDCM 5 comprises RF transceivers, an antenna, a Command a\& Control Unit, a Power Source, a CPU and may include a Display 11. The RDCM receives communication from a LCCS 13 and/or MCS 15 through the mediation of the RFCM 17. The ID module 3 is tethered to the SKU 19 and the RDCM 5 is either tethered or communicates wirelessly with the SKU, as indicated by the dashed line. The RDM 21 running an APP communicates wirelessly with the RDCM 5 and the LCCS 13 and/or MCS 15 via Wi-Fi 22

In operation, the customer has possession of the RDM 21 and when in range of the RDCM can receive from it the information conveyed by the LCCS or the MCS. The RDCM, in its communication with the LCCS and MCS makes use of the information provided by the ID Module. Price information may be provided by the ID Module and that information may be modified by instruction provided to the RDCM from the LCCS or MCS. Thus the entire system is integrated and provides an economical system since only the ID Module has to depart the store along with the SKU after a customer purchase.

Although an example of the invention has been described in some detail, it should be understood that these details are not intended to limit the scope of this patent. The scope of patent coverage is determined on the basis of the claims which follow.

What is claimed is:

1. An electronic price tag system for a vendor's stock keeping units (SKUs) comprising
an ID module physically attached to an SKU for storing information about the SKU appropriate for a price tag,
a Remote Display Module (RDM) having communication and display elements and
a remote display control module (RDCM) connected to and separable from said ID module.
a legacy central computer system (LCCS) or marketing computer system (MCS) which provides information and display the RDM according to communication and control exercised by the RDCM over such information,
an RF Communication Module that mediates communication between the LCCS/MCS and the RDCM.
an WI-FI communication Module that mediates communication between the LCCS/MCS and the RDM,

2. The electronic price tag system for stock keeping units of claim 1, wherein he ID module and/or the RDCM comprise display elements for the information stored in the ID module.

3. The electronic price tag system for stock keeping units of claim 1, wherein the RF Communication Module restricts information from the LCCS/MCS.

4. The electronic price tag system for stock keeping units of claim 1, wherein the RDCM is reusable and comprises a rechargeable or replaceable battery.

5. The electronic price tag system for stock keeping units of claim 1, wherein the RDCM has a limited transmission range that limits access to LCCS/MCS information to users within that range of an SKU.

6. The electronic price tag system for stock keeping units of claim 1, wherein the RDCM comprises security elements that are triggered by unauthorized removal from a vendor's premises.

7. The electronic price tag system for stock keeping units of claim 1, wherein the RDCM comprises security elements that provide for safe removal when an SKU has been checked out and paid for at a store cash register or by the RDM

8. The electronic price tag system for stock keeping units of claim 1, wherein the RDM comprises a smart phone or a mobile device owned by customers or other hand held devices provided temporarily to customers upon entry to the store

9. A Remote Display Control Module (RDCM) to be attached or connected (and paired with RFID sensor) to an SKU or directly to an RFID sensor comprising
an embedded antenna,
an RF transceiver,
a rechargeable or replaceable power source,
a CPU, and
a command and control unit wherein, when excited by receiving a command from a legacy central computer system (LCCS) and/or marketing computer subsystem (MCS), the RDCM transmits a SKU unique Omni RF signal with a strength designed to dissipate at a pre-defined range from the RDCM.

9. An application for vendor to be downloaded to and to operate on a remote display module for enabling the display of SKU specific data residing on a legacy central computer system or on a dedicated marketing computer subsystem, comprising routines to display data selected by the RDCM when the RDM is in a pre-defined range from an SKU.

10. The application of claim 9 further comprising subroutines to enable operations selected from the group consisting of:
shopping list and mapping software to enable indicating the location of SKU's of interest to a customer,
software to suggest a route within a store to a particular SKU and signals to indicate proximity,
software to allow for location of misplaced SKU(s) within a store and provide for restoring these to the intended location,
software to allow the SKUs to be checked out and paid for without having to stop at a cash register
software to provide cumulative total cost for selected items for purchase, and
software interfacing with a social network having product reviews by persons in whom the customer has confidence, and
software to allow the customer to input its own product evaluations to the legacy central computer system or to retain them on an RDM.
